(19) United States
(12) Patent Application Publication
(10) Pub. No.: US 2003/0117382 A1
(43) Pub. Date: Jun. 26, 2003

(54) Configurable panel controller and flexible display interface

(76) Inventors: Stephen S. Pawlowski, Beaverton, OR (US); Vittal Kini, Aloha, OR (US)

Correspondence Address: TROP PRUNER & HU, PC, 8554 KATY FREEWAY, SUITE 100, HOUSTON, TX, 77024, US

(21) Appl. No.: 10/012,968

(22) Filed: Dec. 7, 2001

(51) Int. Cl. G09G 5/00

(52) U.S. Cl. 345/204

(57) ABSTRACT

A panel controller is brought closer to the graphics controller and other components of the video subsystem. The panel controller is reconfigurable, such as by parameters received from the display panel, and is thus useable with multiple different species of display panel.

### BACKGROUND OF THE INVENTION

1. Technical Field of the Invention

The present invention relates generally to video display controllers, and more particularly to a panel controller which dynamically configures itself to work with a display panel, in response to parameters received from the display panel.

2. Background Art

FIG. 1 illustrates a typical display controller system 10 as known in the prior art. A personal computer and its display are chosen as being exemplary of the general principles known in the prior art. The personal computer includes a computer 12 coupled to a display device 14 such as a cathode ray tube (CRT) display or a flat panel display. The computer includes a microprocessor 16 coupled by a processor bus 18 to a chipset 20. The chipset provides support for the various computer subsystems. For example, the chipset is coupled over a memory bus 22 to a memory 24 which is typically dynamic random access memory (DRAM) of one type or another. The chipset is also coupled over a graphics bus 26 such as a peripheral component interconnect (PCI) bus or an accelerated graphics port (AGP) bus to a video card 28.

The video card includes a video memory 30 which stores data representing images, textures, and so forth for display. A graphics controller 34 performs various operations upon those data, and outputs the resulting pixel data via interface logic 36. The interface logic connects the video card to the display device over a video link 38 which is typically any of the analog or digital display interfaces, such as VGA, LVDS, DVI, etc. Corresponding interface logic 40 in the display device receives the pixel data, typically in red-green-blue (RGB) format, which are then handed to a panel controller 42.

The panel controller is coupled over a panel controller bus 44 to a set of digital-to-analog converters (DACs) 46. The DACs are connected over an analog bus 48 to the row and column drivers, which drive the actual display panel 50. The panel is sometimes referred to as the “glass” regardless of whether it is actually constructed of glass or some other material. The panel controller, DACs, and/or other components of the display device may be powered or controlled by a voltage regulation module (VRM) 52.

Display panels come in a wide variety of sizes, resolutions, color depths, and so forth, from a variety of manufactures, and using a wide variety of panel controller interfaces 44. At present, the panel controller must be custom-designed to work with one specific model of display panel. This results in expensive panel controllers, and myriad stock-keeping unit (SKU) numbers, which again raises costs for display device manufacturers. The industry has more or less standardized the video link 38 protocols, connectors, and electrical characteristics, but has not, to date, addressed the problem of customized panel controllers and panel controller interfaces or buses.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 shows a prior art system with a custom panel controller.

FIG. 2 shows a system according to the present invention, using a reconfigurable panel controller.

FIG. 3 shows an exemplary set of signals connecting the panel controller to the display panel.

FIG. 4 shows an exemplary timing diagram for signals in a power-on configuration cycle, in which the display panel provides parameters to configure the panel controller to work with it.

FIG. 5 shows an exemplary timing diagram for signals in a data transfer from the panel controller to the display panel.

FIG. 6 shows one embodiment of a ping-pong buffer system for coalescing data for transmission from the interface to the display sequencer.

FIG. 7 shows one embodiment of a reconfigurable panel controller according to this invention.

FIG. 8 shows a system having its graphics engine and panel controller in one assembly, and its display panel in another assembly.

### DETAILED DESCRIPTION

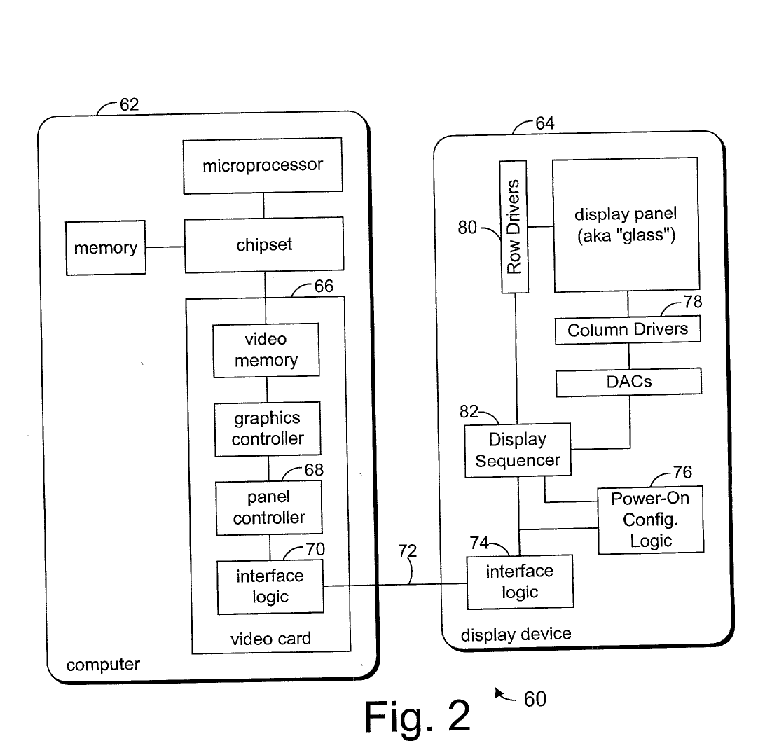

FIG. 2 illustrates a system 60 employing this invention. Again, for ease of illustration, the system is described with reference to a computer 62 and a display device 64, but the invention is not limited to this exemplary case. The invention may be practiced in any electronic or optical system in which a panel controller communicates with a display panel. The system may, in some embodiments, be constructed as a television, a personal computer, a cellular telephone, or any other device.

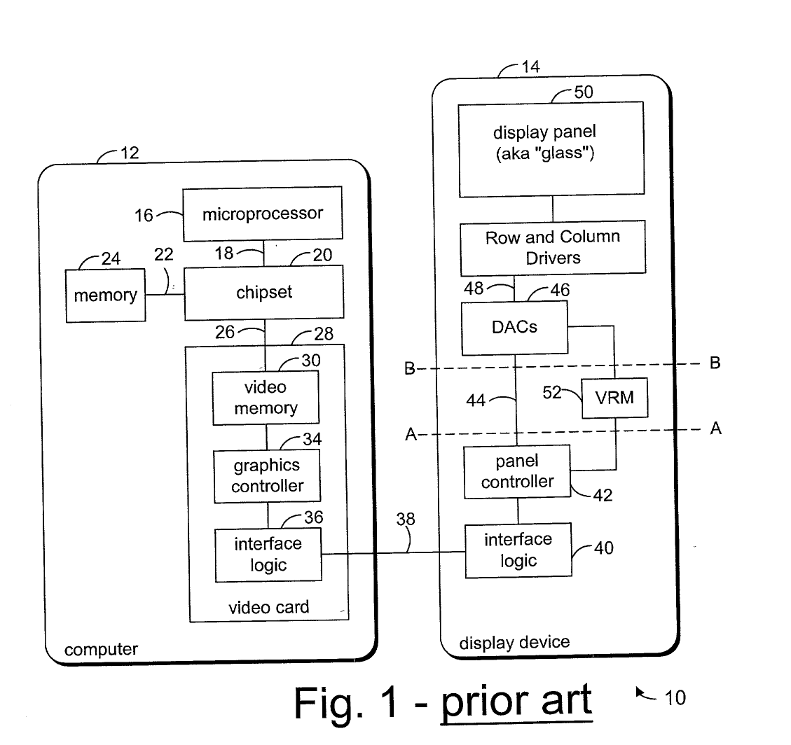

The illustrated system has an improved video card 66 which incorporates the configurable panel controller 68 of the invention. The interface logic 70 of the video card communicates over a communication link 72 to the interface logic 74 of the display device, according to any suitable electrical or optical protocol, using any suitable transport medium, such as serial or parallel wiring, fiber optic cabling, coaxial cable, radio or other wireless link, or the like. The reader should note that the link 72 corresponds more closely to the link 44 (of FIG. 1) than to the link 38 (of FIG. 1), in some respects.

The display device is shown in slightly more detail in FIG. 2 than in FIG. 1. The row drivers it 80 and column drivers 78 drive the pixel data to the display panel, under control of a display sequencer 82. Power-on configuration logic 76 may provide, for example, power-on self testing (POST) of the various functionalities of the display device. The POST logic may also provide configuration parameters to the panel controller upon reset, a reconfiguration command, a wake-up signal, or other such triggering event. The details of the configuration parameters will be discussed later.

As shown in FIG. 2, the system has been repartitioned (at line A-A or B-B of FIG. 1), to move the panel controller closer to the graphics controller. This is especially beneficial in small form factor systems, such as laptop computers, cell phones, palm computers, and the like, in which it is known a priori that the display panel will not be located a long distance from the graphics controller. In some prior art systems, it was felt to be beneficial to use a high-voltage serial cable (38 in FIG. 1) to carry the pixel data, to minimize line losses and reduce noise effects and avoid parallel cross-talk. However, especially (but not exclusively) when the display panel is a short distance from the video engine, a parallel and lower-voltage link 72 can be advantageously employed.

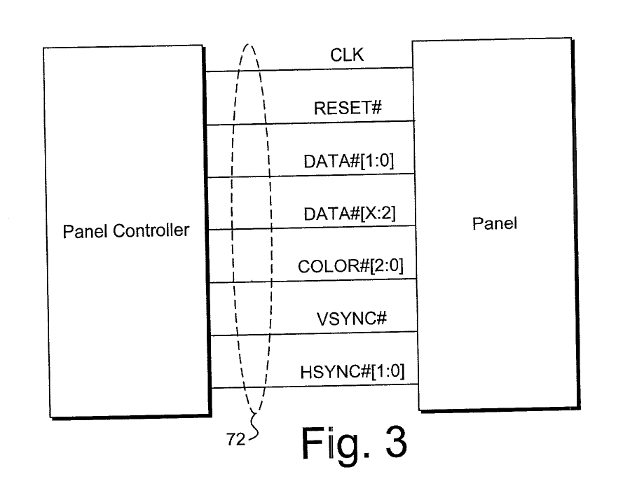

FIG. 3 illustrates one exemplary embodiment of the link 72 which couples the panel controller and the display panel. The reader will appreciate that other embodiments are very much possible and within the scope of this invention. In the following explanation, the shorthand “wire” will be used to indicate a single communication path or channel, and should not be misunderstood to be limited to e.g. a single strand of copper wire. In the example shown, a synchronizing clock signal CLK is provided over a single wire, a reset signal RESET# is provided over a single wire, a vertical synchronization signal VSYNC# is provided over a single wire, a pair of horizontal synchronization signals HSYNC#[1:0] are provided over two wires, and three color indication signals COLOR#[2:0] are provided over three wires.

There are also a number of data signals DATA# which carry the pixel data. In various embodiments, this data bus can have various widths. There is no theoretical minimum or maximum width. In the embodiment shown, there are two data signals DATA#[1:0] that also serve as configuration lines, and the remaining data wires, are designated as DATA#[X:2]. The number of configuration lines is not limited to exactly two.

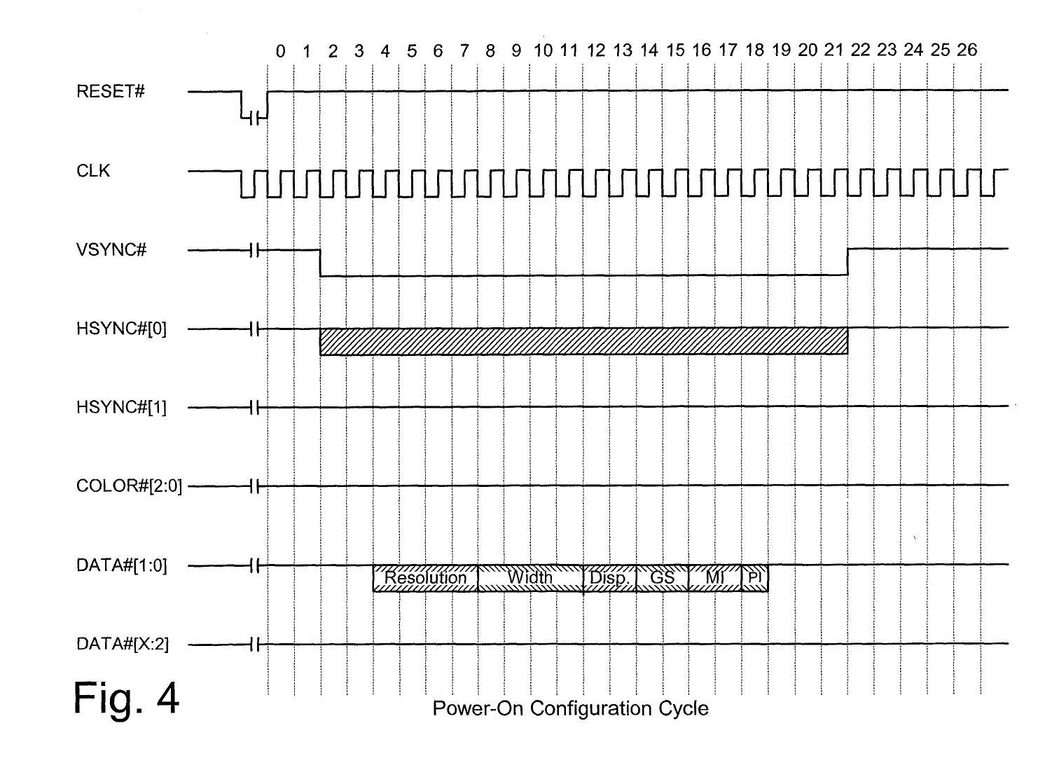

FIG. 4 illustrates a timing diagram of one exemplary set of such signals during one embodiment of a power-on configuration cycle, in which the display panel provides configuration parameters to the display controller, to configure the generic display controller to work specifically with that display panel.

There are many characteristics of a display panel for which such configuration may be desirable. The skilled reader will readily appreciate that this invention may be practiced in a wide variety of configurable panel controllers and display panels, and that the various sets of parameters may differ from case to case. Examples of such parameters include but are not limited to:

TABLE 1
Example Parameters

| | |
|---|---|
| Resolution | the number of pixels, specified in terms of |
| | columns and rows (aka scan lines) in the display |
| | panel, typically expressed as a pair of numbers |
| Data Bus Width | the number of DATA# wires |
| Display Technology | Cathode Ray Tube (CRT), Liquid Crystal Display |
| | (LCD), Organic Light-Emitting Diode (OLED) |
| | display, or the like |
| Gray Scale Support | how many levels of contrast the panel supports in |
| | monochrome mode |
| Modulation Index | the number of bits/pin/clock |
| Scan Type | progressive or interlaced |
| Color Space | RGB, YUV, etc. |
| Min Clock Frequency | lowest clock rate that the display can accept |
| Max Clock Frequency | highest clock rate that the display can accept |
| Preferred Clock | the display's preferred clock rate |
| Scan Rate | frame rate or vertical refresh frequency |
| Degradation | intensity or color adjustment needed to |
| | compensate for aging of display |
| Color Depth | how many bits of color are supported by the |
| | panel's DACs |

In order that the panel controller be able to communicate with a large variety of panels, it is desirable that the configuration information be transferred to the panel controller over wire(s) that are present in the largest quantity of potential panels. In one mode, the low-order two bits DATA#[1:0] of the pixel data wires are used to carry the configuration parameters to the panel controller, as shown in FIG. 4. The reader may also wish to make continued reference also to FIG. 2.

At some arbitrary time, the panel controller takes the RESET# signal active (low) then inactive, resetting the power-on configuration logic, which runs through its POST (typically in clock cycles that are shown in FIG. 4 as a single cycle 0 for ease of illustration). In synchronism with the CLK signal, with VSYNC# active and HSYNC#[1] inactive, the machine is in a configuration cycle. HSYNC#[0] is a don't care, in this embodiment of the invention.

At either a predetermined or an arbitrary number of clock cycles after VSYNC# going active and HSYNC#[1] going inactive, the display panel's power-on control logic (or other suitable means) sends one or more configuration parameters back to the panel controller over the predesignated configuration path, such as DATA#[1:0]. In some embodiments, the actual values of the parameters are passed, such as the numbers 640 and 480 during the Resolution parameter's transfer cycles. In other embodiments, predetermined designators, such as lookup table indices, state machine state numbers, or the like may be passed. Other parameter passing schemes are within the scope of this invention, as well. In some embodiments, parameters may be passed from the controller to the display, in addition to or in lieu of parameters passed from the display to the controller.

In one embodiment, the Resolution is passed over four clock cycles, the Data Bus Width (“Width”) is passed over four clock cycles, the Display Technology (“Disp.”) is passed over two clock cycles, the Gray Scale Support (“GS”) is passed over two clock cycles, the Modulation Index (“MI”) is passed over two clock cycles, and the Scan Type (“PI”) is passed over one clock cycle. Other sets of parameters, other orderings, and other numbers of clock cycles are, of course, within the teachings of this patent.

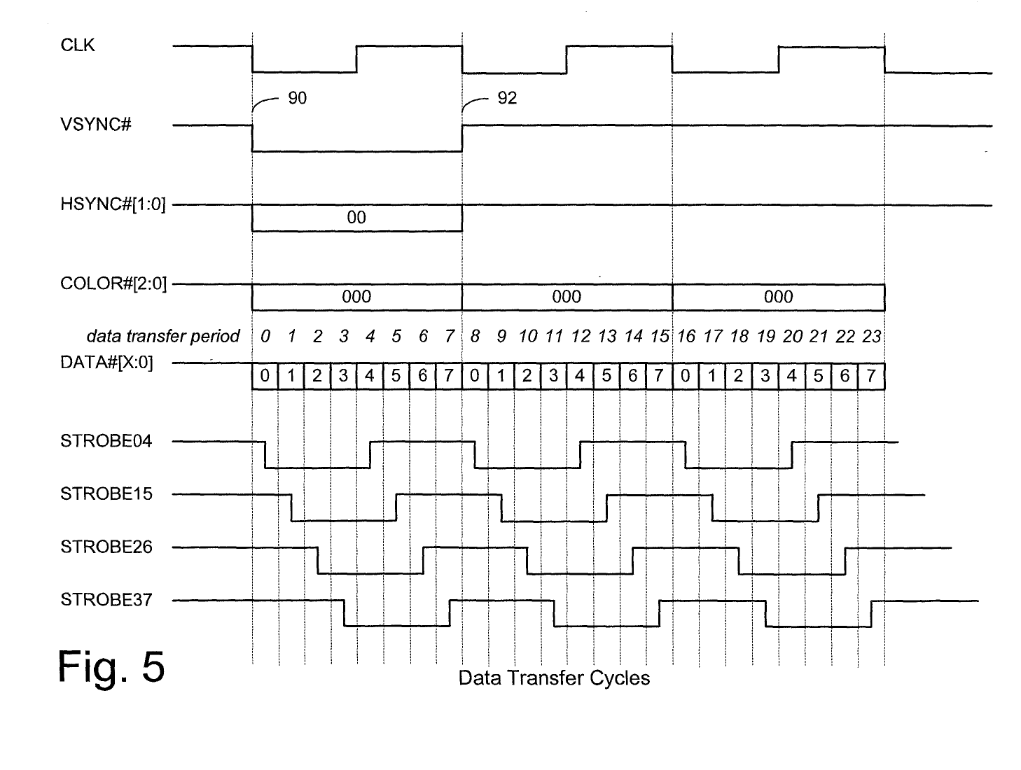

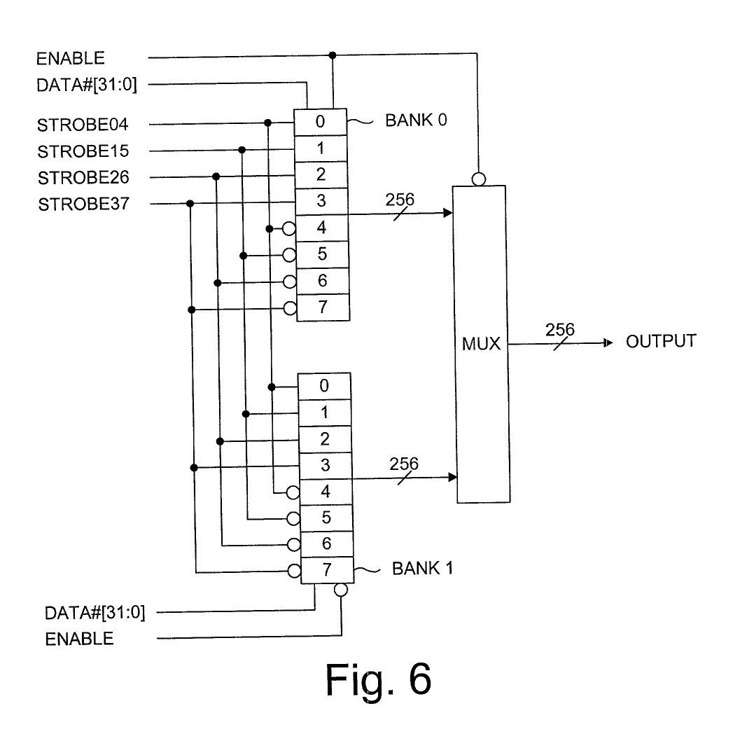

FIGS. 5 and 6 illustrate more detail concerning the Modulation Index functionality. Double-pumped and quad-pumped busses are known, such as those of the Intel® Pentium® Pro, Pentium II, Pentium III, Pentium 4, and Itanium® processors. N-pumping means that N sets of data are transferred per clock cycle, generally by using phase synchronization rather than multi-level signaling.

As shown, during the first full cycle of the CLK clock signal (from 90 to 92), eight data bits (in DATA# signal boxes 0 through 7) are transferred per data wire. In one mode, this is accomplished by latching the data in response to rising and falling edges of four distinct strobe signals STROBE04, STROBE15, STROBE26, and STROBE37. The data lines are coupled to latches (BANK0); for ease of illustration, the data lines DATA#[31:0] are drawn as though touching only the first latch (latch 0), but the reader will appreciate that they are connected to the other latches as well. The number of latches in the bank corresponds to the number of “pumps” per clock cycle; the example given is “eight-pumped” and thus has eight latches (0 through 7 in BANK0). The strobe signals are coupled to respective individual latches. In the mode in which both the rising and falling edges are used as latch triggers, the number of strobe signals is half the number of latches, and each strobe signal is coupled to two latches, one of which has an inverted input. In order to equalize the duty cycle of the strobe, it is desirable that its two latches be equally spaced within the set of latches in the bank (such as latches 0 and 4, or latches 2 and 6).

The panel controller drives the data wires at a higher frequency than the clock signal, and the strobe signals are phase-synchronized to match this frequency multiplication. In one mode, the latch signals are not transmitted as wires between the panel controller and the panel, but are generated within the panel itself, such as within the display sequencer by phase-locked loop or other means.

One reason why the system designer may wish to N-pump the data bus is that, in some cases, the technology of the panel may not allow the various logic devices of the panel to be directly clocked at a frequency sufficient to meet the data transfer rate requirements of the panel. In some panels, it may be desirable to fab the logic directly on the glass; this may result in a maximum logic frequency of 8 MHz, for example. Another solution to this problem is simply to increase the number of data wires, but this drives up the cost and complexity of the display and the display controller. The skilled artisan will understand how to trade off wire count against N-pumping to meet the needs of the application at hand, within the teachings of this patent.

The N-pumping may work in one direction only, in some embodiments; the configuration data may be provided to the panel controller at the CLK clock rate, or perhaps even some fraction of that frequency.

FIG. 6 illustrates a further improvement which may be present in some embodiments of the invention. In order to provide improved buffering, two banks of data latches (BANK0 and BANK1) may be provided, and operates in ping-pong fashion in response to an enable signal (ENABLE, inverted at one bank), as is known in the art. While one bank is filling, the other, already-filled bank is being read and its data are being consumed for display on the panel. A multiplexor (MUX) also responds to the enable signal to select the already-filled bank for reading to output to the panel.

Parameters

Table 2 illustrates one embodiment of encoding the Resolution parameter:

TABLE 2
Resolution

| | |
|---|---|
| 0000 | 160 × 160 |
| 0001 | 320 × 240 (QVGA) |
| 0010 | 320 × 320 |
| 0011 | 640 × 480 (VGA) |
| 0100 | 800 × 600 (SVGA) |
| 0101 | 1024 × 768 (XGA) |
| 0110 | 1280 × 1024 |
| 0111 | 1600 × 1200 (UXGA) |
| 1000 | 1920 × 1080 (HDTV) |
| 1001 | 3640 × 2048 |
| 1010 | reserved |
| and up | |

Table 3 illustrates one embodiment of encoding the Data Bus Width parameter:

TABLE 3
Data Bus Width

| | |
|---|---|
| 000 | 2-bit data bus |
| 001 | 4-bit data bus |
| 010 | 8-bit data bus |
| 011 | 16-bit data bus |
| 100 | 32-bit data bus |
| 101 | 64-bit data bus |
| 110 | reserved |
| 111 | reserved |

Table 4 illustrates one embodiment of encoding the Display Technology parameter:

TABLE 4
Display Technology

| | |
|---|---|
| 000 | CRT |
| 001 | LCD |
| 010 | OLED |
| 011 | plasma |
| 100 | reserved |
| 101 | reserved |
| 110 | reserved |
| 111 | reserved |

Table 5 illustrates one embodiment of encoding the Gray Scale Support parameter:

TABLE 5
Gray Scale Support

| | |
|---|---|
| 00 | reserved |
| 01 | 8-level gray scale (three bits) |
| 10 | 16-level gray scale (four bits) |
| 11 | 256-level gray scale (eight bits) |

Table 6 illustrates one embodiment of encoding the Modulation Index parameter:

TABLE 6
Modulation Index

| | |
|---|---|
| 00 | 8 bits/pin/clock period |
| 01 | 16 bits/pin/clock period |
| 10 | 24 bits/pin/clock period |
| 11 | 32 bits/pin/clock period |

Table 7 illustrates one embodiment of encoding the Scan Type parameter:

TABLE 7
Scan Type

| | |
|---|---|
| 0 | progressive |
| 1 | interleaved |

Table 8 illustrates one embodiment of encoding the Color Space parameter:

TABLE 8
Color Space

| | |
|---|---|
| 00 | RGB |
| 01 | monochrome |
| 10 | YUV |
| 11 | CMYK |

Table 9 illustrates one embodiment of encoding the Min Clock Frequency parameter (and the Max Clock Frequency and Preferred Clock parameters can be done similarly):

TABLE 9
Min Clock Frequency

| | |
|---|---|
| 00 | 8 MHz |
| 01 | 12 MHz |
| 10 | 24 MHz |
| 11 | 32 MHz |

Table 10 illustrates one embodiment of encoding the Scan Rate parameter:

TABLE 10
Scan Rate

| | |
|---|---|
| 00 | 30 Hz |
| 01 | 60 Hz |
| 10 | 75 Hz |
| 11 | 85 Hz |

Table 11 illustrates one embodiment of encoding the Degradation parameter (which can be global to all colors, or could be individually specified for each color):

TABLE 11
Degradation

| | |
|---|---|
| 00 | no degradation, panel controller should send regular color values |
| 01 | 5% degradation, panel controller should boost color intensity 5% |
| 10 | 15% degradation, panel controller should boost color intensity 15% |
| 11 | 25% degradation, panel controller should boost color intensity 25% |

Table 12 illustrates one embodiment of encoding the Color Depth parameter:

TABLE 12
Color Depth

| | |
|---|---|
| 000 | 1-bit color (monochrome) |
| 001 | 8-bit color (2 red, 3 green, 2 blue) |
| 010 | 12-bit color (4 bits each color) |
| 011 | 16-bit color (5 bits red, 6 bits green, 5 bits blue) |
| 100 | 24-bit color (8 bits each color) |
| 101 | 32-bit color (8 bits each color, 8 bits alpha channel) |
| 110 | 48-bit color (16 bits each color) |
| 111 | 64-bit color (16 bits each color, 16 bits alpha channel) |

The panel controller modifies its operation in response to the parameters received from the display panel. In some cases, the panel controller may modify what it presents at its output wires. In other cases, it may modify purely internal operations; for example, if the panel indicates that it has only eight data inputs, and the panel controller has thirty-two data outputs, the panel controller may respond to this parameter by powering down or otherwise disabling the unused data output drivers, to reduce power consumption, minimize cross-talk and noise, and so forth.

There are various other options, configuration parameters, and so forth which may be practiced in the panel controller.

In some embodiments, the panel controller may send all of the red pixel data, then all of the green pixel data, then all of the blue pixel data for the whole image, rather than sending a single pixel's three sub-pixel RGB values, then the next pixel's, and so forth. In many or perhaps most images, there are large blocks adjacent pixels having relatively uniform color, especially within each sub-pixel color (R or G or B). In some embodiments, it may be a configuration parameter whether to operate in normal “RGB RGB RGB . . . ” space or in “all R, all G, all B” space.

Furthermore, there are color spaces other than RGB, such as YUV, CMYK, gray scale, and monochrome. This invention may be practiced within any or all of those, and their selection can, in some embodiments, be a configuration parameter.

In many cases, only a very small percentage of the video image changes from frame to frame. In many cases, there are very long periods of time—minutes or even hours—with zero pixel data change. In these cases, it is wasteful of energy to repeatedly send the same pixel data over and over from the panel controller to the panel display. This is especially significant in battery-powered applications. In some such embodiments, it may be desirable to provide a “sparse refresh” mode in which only the “delta” is transmitted from frame to frame. It may further be desirable to provide a “no updates until further notice” mode, which instructs the panel display to continue displaying the same data over and over. This is especially useful when the display panel is a flat-panel display of the type in which each pixel has its own memory cell of a type not requiring an outside data value in order to perform a refresh cycle. Details of sparse refresh can be configuration parameters.

Especially desirable in battery-powered operations is a reduced power mode in which the display panel can reduce its power consumption when the battery reaches a low charging threshold, such as a predetermined charge level. One such power reduction mode is to turn off a backlight of a reflective panel display. Another is to reduce the brightness of the display. Another is to invert the display of a black-on-white image (such as in a word processing application) to a less power consuming white-on-black image. Those techniques are known, although not as configuration parameters for a panel controller. Another, believed to be new to this disclosure, is to turn off one or more of the colors of a display, upon a low power condition. In an RGB display, most of the significant perceptual content is generally in the green image data. Upon reaching a low battery condition, a system using the teachings of this disclosure could reconfigure its panel controller to omit red and blue (perhaps together, perhaps in series) from the display. This would not only reduce the power consumed directly by the display in generating the red and blue photons, but would also reduce the power consumed by the panel controller (which could power down those respective circuits) and also the power lost driving the link to the panel.

In some applications, such as those in which the display panel pixels have a relatively long persistence, it may be suitable to, in this low power configuration, switch back and forth between subsets of the available colors. For example, only the green data might be sent and displayed for a time, then the red data and/or blue data might be sent and displayed for a time. By having each color “off” for much of the time, the overall power consumption may be reduced, while, by switching back and forth between the colors, a suitable color image may still be displayed, especially where the pixels exhibit long persistence. In some embodiments, it may be sufficient to switch between colors e.g. ten times per second.

In some display panels, there is a “charge gathering” effect, in which, over time, the display element cells could gradually accumulate charge, which can alter the actual color output versus the color data that are specified. This charge can periodically be bled off, known as “auto-zeroing” the pixel.

Table 3 illustrates one embodiment of encoding the COLOR#[2:0] signals, to accomplish this:

TABLE 13
COLOR#[2:0]

| | |
|---|---|
| 000 | draw red pixel |
| 001 | draw green pixel |
| 010 | draw blue pixel |
| 011 | reserved |
| 100 | auto-zero red pixel |
| 101 | auto-zero green pixel |
| 110 | auto-zero blue pixel |
| 111 | reserved |

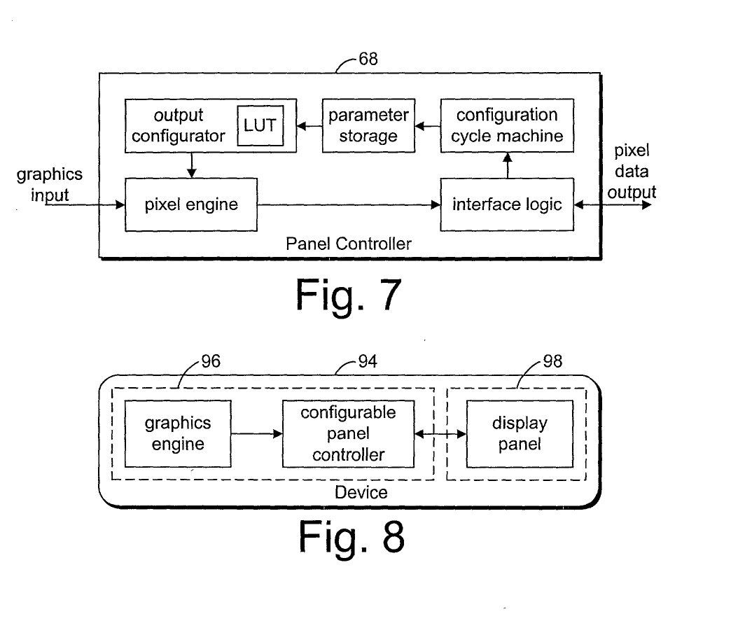

FIG. 7 illustrates one exemplary embodiment of the panel controller 68 which receives graphics input (from the graphics controller, not shown) and provides pixel data output (to the display panel, not shown). The graphics input data are processed by a pixel engine and sent through the interface logic onto the output bus. A configuration cycle machine, such as a state machine or other suiutable mechanism, is coupled to the interface logic to detect and handle parameters received from the other display panel. Parameter storage, such as registers, may be used to store the received parameters. An output configurator retrieves the parameter data from the parameter storage, and uses them to configure the pixel engine. In embodiments in which the display panel provides indirect parameters (e.g. “resolution three”) rather than actual parameter values (“resolution 640×480”), the output configurator includes e.g. a lookup table (LUT) that contains the actual parameter values.

FIG. 8 illustrates a device 94 in which the graphics engine and the configurable panel controller are in one assembly 96, while the display panel is in another, separate assembly 98. In some embodiments, these assemblies may comprise separate monolithic building blocks. In others, they may comprise separate sub-assemblies each made of multiple components. For example, the graphics engine and the panel controller may be separate chips affixed to a printed circuit board, while the display panel is coupled to a separate circuit board. Or, the graphics engine and configurable panel controller may be fabricated together on a monolithic chip, and that single chip and the display panel may be affixed to the same printed circuit board. Or, the physical connection between the graphics engine and the configurable panel controller may simply be of a shorter physical length than the link between the configurable panel controller and the display panel.

The reader should appreciate that drawings showing methods, and the written descriptions thereof, should also be understood to illustrate machine-accessible media having recorded, encoded, or otherwise embodied therein instructions, functions, routines, control codes, firmware, software, or the like, which, when accessed, read, executed, loaded into, or otherwise utilized by a machine, will cause the machine to perform the illustrated methods. Such media may include, by way of illustration only and not limitation: magnetic, optical, magneto-optical, or other storage mechanisms, fixed or removable discs, drives, tapes, semiconductor memories, organic memories, CD-ROM, CD-R, CD-RW, DVD-ROM, DVD-R, DVD-RW, Zip, floppy, cassette, reel-to-reel, or the like. They may alternatively include down-the-wire, broadcast, or other delivery mechanisms such as Internet, local area network, wide area network, wireless, cellular, cable, laser, satellite, microwave, or other suitable carrier means, over which the instructions etc. may be delivered in the form of packets, serial data, parallel data, or other suitable format. The machine may include, by way of illustration only and not limitation: microprocessor, embedded controller, PLA, PAL, FPGA, ASIC, computer, smart card, networking equipment, or any other machine, apparatus, system, or the like which is adapted to perform functionality defined by such instructions or the like. Such drawings, written descriptions, and corresponding claims may variously be understood as representing the instructions etc. taken alone, the instructions etc. as organized in their particular packet/serial/parallel/etc. form, and/or the instructions etc. together with their storage or carrier media. The reader will further appreciate that such instructions etc. may be recorded or carried in compressed, encrypted, or otherwise encoded format without departing from the scope of this patent, even if the instructions etc. must be decrypted, decompressed, compiled, interpreted, or otherwise manipulated prior to their execution or other utilization by the machine.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A panel controller for use with a display panel, the panel controller comprising:
interface logic for connecting the panel controller to the display panel;
a pixel engine coupled to the interface logic for generating output pixel data to be sent to the display panel; and
an output configurator coupled to the interface logic and the pixel engine, to configure at least one operating characteristic of the pixel engine in response to at least one parameter received from the display panel.

2. The panel controller of claim 1 wherein:
the interface logic is further for receiving the parameter from the display panel over a communication path that also carries at least some of the output pixel data to the display panel.

3. The panel controller of claim 1 wherein the at least one operating characteristic comprises at least one of:
resolution;
data bus width;
display technology;
gray scale support;
modulation index;
scan type;
clock frequency;
scan rate;
degradation; and
color depth.

4. The panel controller of claim 1 further comprising:
a lookup table for converting a received indirect parameter into a parameter value.

5. The panel controller of claim 1 further comprising:
parameter storage to store received parameters.

6. The panel controller of claim 1 further comprising:
a configuration cycle machine for detecting incoming parameters.

7. The panel controller of claim 1 further comprising:
a video card containing the panel controller and a graphics controller.

8. An apparatus comprising:
a graphics controller;
a display panel; and
a configurable panel controller coupled to receive graphics data from the graphics controller, coupled to provide pixel data to the display panel, and coupled to receive at least one configuration parameter from the display panel.

9. The apparatus of claim 8 wherein the configurable panel controller is responsive to the at least one configuration parameter to modify at least one operational characteristic of the configurable panel controller in response thereto.

10. The apparatus of claim 9 wherein the configurable panel controller is responsive to at least one parameter selected from the group comprising resolution, data bus width, display technology, gray scale support, modulation index, scan type, clock frequency, scan rate, degradation, and color depth.

11. The apparatus of claim 9 wherein the configurable panel controller is responsive to the configuration parameter to adjust an output resolution of the configurable panel controller.

12. The apparatus of claim 9 wherein the configurable panel controller includes more than two pixel data output channels and is responsive to the configuration parameter to select a subset of the pixel data output channels to transmit pixel data to the display panel.

13. The apparatus of claim 12 wherein the subset of the pixel data consists of two pixel data output channels.

14. The apparatus of claim 8 constructed as a television.

15. A method for a panel controller to provide pixel data to a display panel, the method comprising the panel controller:
receiving a configuration parameter from the display panel; and
configuring an operational characteristic of the panel controller in response to the configuration parameter.

16. The method of claim 15 wherein configuring the operational characteristic comprises:
altering the pixel data.

17. The method of claim 15 wherein configuring the operational characteristic comprises:
adjusting control logic in the panel controller to scale an output image to match a resolution of the display panel.

18. The method of claim 15 wherein configuring the operational characteristic comprises:
selecting a subset of pixel data output channels to carry the pixel data to the display panel.

19. The method of claim 15 wherein configuring the operational characteristic comprises:
adapting operation of the panel controller according to a display technology type of the display panel.

20. The method of claim 15 wherein configuring the operational characteristic comprises:
setting a number of gray scale levels output by the panel controller.

21. The method of claim 15 wherein configuring the operational characteristic comprises:
selecting a modulation index for pumping pixel data to the display panel at a multiple of a clock frequency of the display panel.

22. The method of claim 21 wherein the multiple is one of two, four, eight, sixteen, and thirty-two, and the pumping comprises sending multiple bits per pixel data channel in a phased pumping arrangement.

23. The method of claim 15 wherein configuring the operational characteristic comprises:
outputting one of progressive scan lines and interlaced scan lines as determined by the parameter.

24. The method of claim 15 wherein configuring the operational characteristic comprises:
selecting a clock frequency.

25. The method of claim 15 wherein configuring the operational characteristic comprises:
selecting a scan rate.

26. The method of claim 15 wherein configuring the operational characteristic comprises:
adjusting pixel data output to compensate for degradation of the display panel.

27. The method of claim 26 wherein adjusting comprises altering a brightness level of pixel data.

28. The method of claim 15 wherein configuring the operational characteristic comprises:
selecting a color space.

29. The method of claim 15 wherein configuring the operational characteristic comprises:
selecting a color depth.

30. A method comprising:
sending a configuration parameter from a display panel to a panel controller;
reconfiguring the panel controller in accordance with the configuration parameter; and
sending pixel data from the panel controller to the display panel in a manner different than would have been but for the reconfiguring.

31. The method of claim 30 wherein:
the sending comprises sending more than one configuration parameter;
the reconfiguring is further in accordance with the more than one configuration parameter; and
the sending pixel data is further in a manner different in more than one respect, in accordance with the more than one configuration parameter.

32. The method of claim 31 wherein:
the more than one configuration parameter comprise a resolution parameter and a data width parameter; and
the sending pixel data comprises sending pixel data having a resolution indicated by the resolution parameter and sending the pixel data over a subset of available pixel data outputs of the panel controller.

33. The method of claim 30 further comprising:
sending auto-zero signals from the panel controller to the display panel; and
responsive to the auto-zero signals, bleeding off accumulated charge in pixels of the display panel.

34. The method of claim 30 further comprising, within sending pixel data for a single video frame:
sending all pixel data for a first color; and then
sending all pixel data for a second color.

35. An electronic data processing device comprising:
a microprocessor;
a graphics controller coupled to the microprocessor;
a display panel; and
a panel controller coupled to receive graphics data from the graphics controller and coupled to provide pixel data to the display panel and to receive a configuration parameter from the display panel.

36. The electronic data processing device of claim 35 wherein the electronic device is a personal computer.

37. The electronic data processing device of claim 35 wherein the electronic device is a palm computer.

38. The electronic data processing device of claim 35 wherein the electronic device is a cell phone.

39. The electronic data processing device of claim 35 wherein the electronic device is a laptop computer.

40. The electronic data processing device of claim 35 wherein the panel controller is bidirectionally coupled to the display panel over at least two pixel data channels to receive the configuration parameter.

41. The electronic data processing device of claim 35 further comprising, in the panel controller:
means for performing sparse refresh of the display panel.

42. The electronic data processing device of claim 35 wherein the electronic data processing device comprises a television.

43. A method of operating a battery-powered device having a panel controller that provides pixel data to a display panel, the method comprising:
detecting that a battery charge is below a predetermined threshold; and in response thereto
reconfiguring the panel controller to provide altered pixel data to the display panel.

44. The method of claim 43 wherein the reconfiguring comprises modifying operation of the panel controller to provide reduced brightness pixel data to the display panel.

45. The method of claim 43 wherein the reconfiguring comprises modifying operation of the panel controller to provide a subset of available colors to the display panel.

46. The method of claim 45 wherein the available colors comprise red, green, and blue pixel data, and the subset is the green pixel data.

47. The method of claim 45 further comprising:
selecting a first subset of available colors and providing the first subset to the display panel during a first time; then
selecting a second subset of available colors and providing the second subset to the display panel during a second time.

48. The method of claim 47 wherein the first subset comprises green, the second subset comprises red and blue, and the method further comprises alternately switching back and forth between the first and second subsets over time.

49. The method of claim 48 wherein the alternately switching back and forth is repeated more than ten times per second.

50. An article of manufacture comprising:
a machine-accessible medium having thereon data which, when accessed by a machine, enable the machine to create a semiconductor device including,
a graphics controller, and
a panel controller that is reconfigurable to operate with any one of multiple display panels that have different input requirements, the panel controller having a configuration cycle machine, an output configurator, and a pixel engine.

51. The article of manufacture of claim 50 wherein the machine-accessible medium has additional data that, when accessed by the machine, enable the machine to include in the semiconductor device:
parameter storage to store parameters received by the panel controller from a display panel.

52. A business method comprising:
assembling a first apparatus including,
a first graphics controller,
a first parameter-configurable panel controller of a first controller type, coupled to the first graphics controller, and
a display panel of a first panel type, coupled to the first parameter-configurable panel controller;
assembling a second apparatus including,
a second graphics controller,
a second parameter-configurable panel controller of the first controller type, coupled to the second graphics controller, and
a display panel of a second panel type, coupled to the second parameter-configurable panel controller;
wherein the first panel type and the second panel type are incompatible with each other in at least one characteristic of the input data they require from their respective panel controllers;
shipping the first apparatus; and
shipping the second apparatus.

53. The business method of claim 52 wherein:
assembling the first apparatus further includes,
selecting the first parameter-configurable panel controller according to a first SKU; and
assembling the second apparatus further includes,
selecting the second parameter-configurable panel controller according to the first SKU.

54. The business method of claim 53 wherein the first apparatus and the second apparatus each comprise one of:
a cellular telephone;
a personal computer;
laptop computer;
palm computer;
a personal digital assistant;
a calculator; and
a television.

55. The business method of claim 54 wherein the first apparatus and the second apparatus comprise the same one of that list.

56. The business method of claim 54 wherein the first display type and the second display type are different ones of:
CRT;
LCD;
OLED; and
plasma display.

57. The business method of claim 53 wherein the at least one characteristic of the input data comprises any of:
resolution;
data bus width;
display technology;
gray scale support;
modulation index;
scan type;
clock frequency;
scan rate;
degradation; and
color depth.
